(19) United States
(12) Patent Application Publication
(10) Pub. No.: US 2008/0315538 A1
(43) Pub. Date: Dec. 25, 2008

(54) Leveling system and device for a recreational vehicle

(76) Inventor: Michael Ogle, Baker City, OR (US)

Correspondence Address: PETER A. HAAS, ESQUIRE, 1929 SW 13TH AVENUE, PORTLAND, OR, 97201, US

(21) Appl. No.: 12/142,205

(22) Filed: Jun. 19, 2008

Related U.S. Application Data
(60) Provisional application No. 60/945,505, filed on Jun. 21, 2007.

(51) Int. Cl. B60S 9/00

(52) U.S. Cl. 280/6.153

(57) ABSTRACT

A system for leveling recreational vehicles and the like consists of two motors operating simultaneously but independently to lift a trailer or other vehicle having vehicle-axles. The system comprises one portable and motorized lifting unit that can be deployed selectively on either side of the vehicle, or both, as required. The motorized lifting unit comprises a pair of motorized jacking units connected by a common and centrally positioned tube-type rail member. A pair of motorized jacking units electrically couple to a controller. The vehicle battery or another external power supply powers both electric motors.

### PRIORITY CLAIM

The present application claims benefit under 35 U.S.C. Section 119(e) of U.S. Provisional Patent Application Ser. No. 60/945,505, filed on 21 Jun. 2007, the disclosure of which is expressly incorporated by reference for all purposes.

### BACKGROUND

This invention relates to a vehicle chassis-to-ground leveling apparatus and, more specifically, to a vehicle-leveling device adapted for use with recreational vehicles.

Recreational vehicles, motor-homes, travel trailers, and luxury coaches, for example, routinely serve as second homes, vacation homes, mobile work-centers, and even primary homes for thousands of users. Not surprisingly, the variety of vehicles and the situations, locations, and terrain where such useful vehicles are parked equally varies. Leveling the vehicle so the interior compartment presents as-near-as-possible true horizontal floor, is a common problem because of uneven terrain and this problem is further accentuated when a vehicle parks on an incline—in such situations each wheel, axle, or corner of the vehicle needs a unique adjustment of height from the ground to afford a level interior.

Many attempts have been made to provide vehicles with a system that enables an operator to level the vehicle relative to the ground when parked. For example, some vehicles include a system of jacks consisting of multiple hydraulic or motorized lift or leveling jacks position at three or four locations under a vehicle combined with a control panel adapted to enable the user to control the individual height of each associated jack.

As a representative example of a system using hydraulic jacks, U.S. Pat. No. 5,188,379 to Krause et al. issued on 23 Feb. 1993, includes a plurality of hydraulic jack assemblies located adjacent to the wheels of a recreational vehicle. To affect automatic leveling, the Krause device includes a combination of electrical level sensors and pressure sensors. As the hydraulic jack at each wheel extends downward at a first (low) pressure, a pressure sensor detects contact of the jack with the ground. Once this pre-determined threshold low pressure is detected, the system incorporates a hydraulic manifold assembly regulates the flow of hydraulic fluid to each individual jack to ensure that a maximum pressure threshold is not exceeded when leveling the vehicle. Although this system adequately provides for leveling the vehicle, the system includes a large number of components that adds costs and complexity to the system. This affects reliability and practically precludes retrofitting existing vehicles that do not have the system pre-installed.

Another system, described by Trudeau et al. in U.S. Pat. No. 7,261,304 issued on 28 Aug. 2007, includes at least one level sensor, a controller and an output as part of a vehicle leveling system. The senor measures how level the vehicle is relative to a horizontal reference plane. The controller and sensors adapt to enable the Trudeau system to provide automatic and best leveling features of the system. For the Trudeau system to operate correctly, a number of steps and components are required to install the system on a vehicle chassis. For example, bubble-levels are required to ensure that the mounting plates containing the sensors are properly aligned with the chassis to avoid erroneous readings of the sensors, which would affect the system's ability to level the vehicle. The number of components, the complexity of the components, and the precision of installation, for example, of the Trudeau system add complexity, cost, and therefore, may not ideally suit every chassis situation or be available to retrofit existing vehicles in a cost-effective and reliable manner.

U.S. Pat. No. 5,205,586 issued to Tallman on 27 Apr. 1993 describes a multi-purpose structure for vehicles consisting of a pair of telescoping beams which serve in part as a cross-member or beam beneath the floor of the vehicle and also in part as guideways for trunnions which are attached to upper ends of ground-engaging legs. The legs serve as stabilizers when the vehicle is parked. The same telescoping beams additionally serve as housing for jack screw drives which are used to move the stabilizing legs between ground-engaging and stowed positions. This structure permanently attaches to virtually anywhere on the vehicle frame and is an integrated structural member, which serves, in part, to reduce overall cost of the vehicle yet provide auxiliary stability when parked. As such, the disclosed structure is ill-suited to portable use and is further limited by a manual jack-screw, which necessitates considerable manual effort to turn. Further, this structure lacks any means for determining whether the vehicle is level, thus relying on the operator's skill.

Thus, there remains a need for a portable, economical, light-weight and easy to use apparatus designed to quickly level a recreational vehicle. Further, such an apparatus should include means for determining whether the vehicle is level and such means should not be operator dependent. Additionally, such a device should reduce the number of components and complexity of known systems. Such a system should be adaptable for retrofitting to existing vehicles.

### SUMMARY OF THE INVENTION

In one embodiment of the present invention, a system for leveling recreational vehicles and the like consists of two motors operating in unison to lift two vehicle-axles simultaneously. The system comprises one portable and motorized lifting unit that can be deployed selectively on either side of the vehicle. The motorized lifting unit comprises a pair of motorized jacking units connected by a common and centrally positioned tube-type rail member measuring about 40-inches in overall length. The pair of motorized jacking units electrically couple to a male receptacle about 3-feet extended. This male receptacle selectively couples to and is otherwise joined by a female receptacle, which connects to the two up and down switches via an electrical cable. The electrical cable is then joined about 6-inches beyond to make one line, which extends to the battery connector.

Each jack lifts about 4,000 lbs starting at about 5″ from a level surface, such as the ground). This equates to each pair adapts to lift about 8,000-lbs of load. Commonly, RV suspension springs locate from about 5-inches from the ground. The tire needs to be raised no more than about 6-inches to about 9-inches, plus an additional about 6-inches for an overall range of extension of about 15-inches. The scissor-part of the jacks should be as wide as practically possible to make the jack as sturdy as possible.

Typically, vehicle axles are about 33-inches apart on a recreational vehicle.

The electric motors couple to a battery provided by the vehicle.

A hard rubber pad to contacts the springs between the shackle bolts and wedges themselves therein, thus increasing the stability factor and reducing the possibility of slippage. Wider jacks and bases increase stability so that when the corner stabilizers are set, the trailer will be very stable for people to move around inside.

A magnetized and heat-resistant bubble level, robust in design to maintain its shape and functionality ensures that the RV is adjusted to be level. The level magnetically couples to the trailer frame.

A carrying case, large enough to house the unit and the accessories, includes a strong handle and closes with a secure snap, yet remains easy to open.

An electrical extension line extends about 20-feet in length with a male connector on one end and a female connector on the other end. A plastic H-type holder adapts to accept the cord when wrapped up. A mating female connector electrically couples to the battery and includes a weatherproof cap.

A lightweight rod with a partial hook extending about 3-feet in length aids in moving the unit under the trailer.

Once the present invention levels and blocks one particular side of the RV, normal stabilizing equipment, as generally understood in the art, supports and maintains the levelness of the RV while it is parked.

One key advantage of the present invention is that the trailer or recreational vehicle can be parked in the desired location and the vehicle's driver can simply, take the device according to the teachings of the present invention and place it under the trailer or RV at the low side and simultaneously lift the same side of both the front and rear axle while simultaneously adjusting fore-aft levelness of the trailer or RV, then block that side without repositioning the trailer or RV. Then, the corner stabilizers are deployed as normally would be done. This device improves the present state of the art because prior-art devices require blocks of varying types that have to be placed in the path of the trailer wheels, then driven onto, hoping that the correct height is chosen to level the trailer. If the trailer is not fairly level this process has to be repeated. They then have to block the other side before unhooking, leveling front to back, and setting out the stabilizers.

Other advantages include:

A lightweight yet sturdy construction weighing approximately 20 pounds and is designed to lift 8,000 pounds;

Only one side of the trailer is lifted at any time so it is designed to accommodate up to 16,000 pound trailers;

It will lift and block at the same time. No need for additional blocks;

Can be used to change flats on the trailer;

It is portable and can be used on multiple trailers/RV's. For example, if an owner buys a new RV he can take the device to the new RV;

It is easily stored as it is in a carrying case measuring 41 inches long, 7 inches wide and 7 inches high;

A plastic H-type holder adapts to selectively accept excess cable length and serves as a cable holder when the device is not in use; and

The unit is electrically powered, backed up by a manual crank in case of emergency.

### DRAWING

FIG. 1 is a schematic side view of one embodiment of the present invention.

FIG. 2 is a schematic top view of an RV trailer, which is one environment of use of the present invention.

FIG. 3 is a top view of the embodiment of FIG. 1 illustrating the present invention as used on an RV trailer.

FIG. 4 is a side view of the embodiment of FIG. 3.

FIG. 5 is a side view of an alternative embodiment of the present invention illustrating the device in a first, retracted position.

### DESCRIPTION OF THE INVENTION

Possible embodiments will now be described with reference to the drawings and those skilled in the art will understand that alternative configurations and combinations of components may be substituted without subtracting from the invention. Also, in some figures certain components are omitted to more clearly illustrate the invention.

In one embodiment, the present invention comprises a leveling system for a recreational vehicle having at least two axles. FIG. 2 shows a typical recreational vehicle RV having an on-board power source such as battery B with tandem axles A1 and A2, each axle having at least a pair of wheels W.

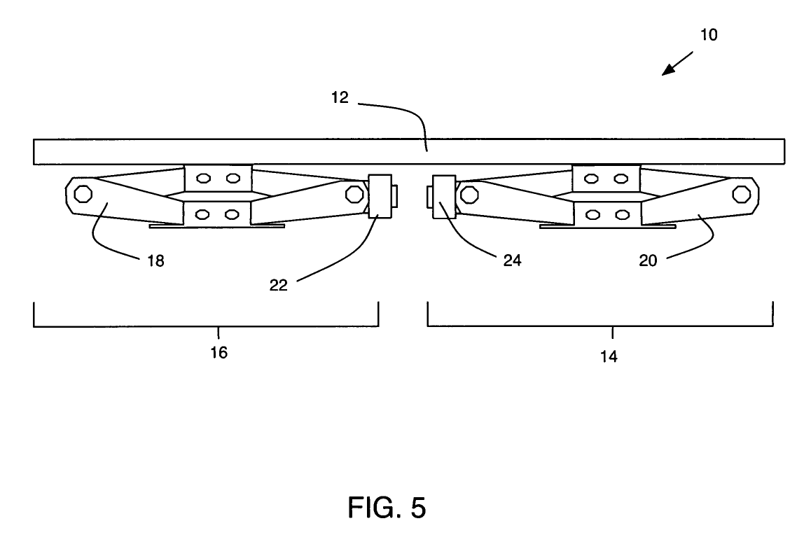

In one preferred embodiment (as FIG. 5 exemplarily illustrates), the present invention includes a leveling system for a vehicle having at least two axles, the leveling system comprises: A tube-type rail member 12 having a top surface adapted to selectively and simultaneously engage the two vehicle axles; a first jack unit 16 couples to a bottom surface of the rail, the first jack unit comprising a first scissors-type mechanical jack 18 device having an associated first screw drive member 22; and a second jack unit 14 couples to the bottom surface of the rail, the second jack unit comprises a second scissors-type mechanical jack device 20 having an associated second screw drive member 24.

The system further includes a means for selectively coupling the first and second jack units to a remote power source whereby the remote power source comprises an automotive battery, the battery is provided by the recreational vehicle in one instance, or may be a separate power unit independent of the vehicle. The means for selectively coupling the first and second jack units to a remote power source includes cables that are in electrical communication with the respective jack units and the power source. The cable further includes—in one preferred embodiment—a suitable male or female connector that adapts to mate to a paired and opposite connector on the power source. In other contemplated and preferred embodiments, the cable may be spliced or soldered directly to the power source—however, having a mechanical connector provides many advantages as would be well understood in this field. Similarly, the jack units may be connected serially or in parallel with power source, as this configuration detail is not crucial to the invention.

The system further includes a control box comprising a first up/down switch communicating with the first jack and a second up/down switch communicating with the second jack. The communication can occur wirelessly, or in a preferred embodiment the respective switches are electrically in communication via a cable and are in communication with the first and second screw drive members, each member being further adapted to couple to a respective associated first and second electric motors, the control box comprising control elements to actuate each first and second electric motor.

In this preferred embodiment, the present invention includes means for manipulating the first and second jack units when an external battery is not available. In this case, the power source is a human-operated hand winch. As such, the leveling system further includes a hand winch assembly adapted to selectively couple to either the first or second screw drive member to enable manual manipulation of the respective first or second scissors-type mechanical jack device to enable operation of the system without use of the remote power source.

In anther preferred embodiment of the present invention, a leveling device adapts for use with a vehicle having at least one axis, the leveling device comprises a rail member 12, a first jack mechanism 16 coupled to the rail member where the first jack mechanism comprises a first driving means 22 for selectively extending and retracting from a first-jack first position (compressed) to a first-jack second position (extended). The leveling device further includes a power means coupled to the driving means and a controller means coupled to the driving means and adapted to selectively control the driving means to enable extension and retraction from the first-jack first and second positions. Further, the leveling device also includes a second jack mechanism 14 coupled to the rail member. The second jack mechanism comprises a second driving means 24 for selectively extending and retracting from a second-jack first position to a second-jack second position. The second driving means couples to the power means and to the controller means to enable extension and retraction from the second-jack first and second positions.

In one preferred embodiment, the leveling device includes a first driving means comprising an electric motor coupled to the power means, the motor adapted selectively rotate clockwise and selectively rotate anti-clockwise an associated a screw-drive shaft, a scissors-type mechanical jack assembly comprising a ground plate coupled to a first end of a scissors-frame adapted to retract and extend from the first-jack first position to the first-jack second position, the first scissors-type mechanical jack assembly adapted to engage the screw-drive shaft, and a second end coupled to the rail member.

Further, the leveling device includes a second driving means comprising an electric motor coupled to the power means, the motor adapted selectively rotate clockwise and selectively rotate anti-clockwise an associated a screw-drive shaft; a second scissors-type mechanical jack assembly comprising a ground plate coupled to a first end of a scissors-frame adapted to retract and extend from the first-jack first position to the first-jack second position, the first scissors-type mechanical jack assembly adapted to engage the screw-drive shaft, and a second end coupled to the rail member.

The power means includes a remote power source such as a battery storage device or human-power via a hand-operated winch handle adapted to selectively couple to either the first or second driving means.

The power means further includes a cable adapted to couple to a remotely located battery and further adapted to provide power to the controller means.

The rail member 12 further comprises a segment of hollow tubing having oppositely spaced and open ends and further having a rectangular cross-section consisting of steel, aluminum or similar metal.

In a preferred embodiment, the leveling device includes a controller means for enabling independent operation of the first and second jack units from a retracted first position to an extended second position and back. The controller means further comprises a control box adapted to house a first switch, the first switch being in electrical communication with, and adapted to selectively enable operation of, the first jack mechanism to extend and retract from its first position to its second position; and the control box further adapted to house a second switch, the second switch being in electrical communication with, and adapted to selectively enable operation of, the first jack mechanism to extend and retract from its first position to its second position.

In another preferred embodiment, the present invention contemplates a device and method of use for leveling a trailer or other vehicle having two axels. This method includes the steps of providing a leveling device having a rail member coupled to a first jack mechanism and a second jack mechanism whereby the first and second jack mechanism further comprise an associated first and second electric motor, each motor being independently operable between a respective first and second position by a controller means; coupling the leveling device to a power source; placing the leveling device under the trailer or other vehicle at a first under-vehicle location so that the rail member aligns with the two axels and extending the respective first and second jack mechanisms so the rail member contacts the respective axel; and extending the first and second jack mechanism to a first desired position to cause the trailer or vehicle to be aligned in a fore-aft and left-right first level position.

Additionally, this method further contemplates placing blocking means under the trailer wheels; retracting the leveling device; and removing the leveling device from under the trailer or other vehicle.

Also, this method further includes placing the leveling device under the trailer or other vehicle at a second under-vehicle location so that the rail member aligns with the two axels and extending the respective first and second jack mechanisms so the rail member contacts the respective axel; and extending the first and second jack mechanism to a second desired position to cause the trailer or vehicle to be aligned in a fore-aft and left-right first level position.

In another embodiment, the present invention adapts to enable a repair of the vehicle and includes a method comprising repairing the vehicle while the leveling device is in the first desired position.

And finally, the device may be stored on the vehicle and selectively placed under the axel as required. Accordingly, the method includes selectively storing the leveling device on the trailer or other vehicle.

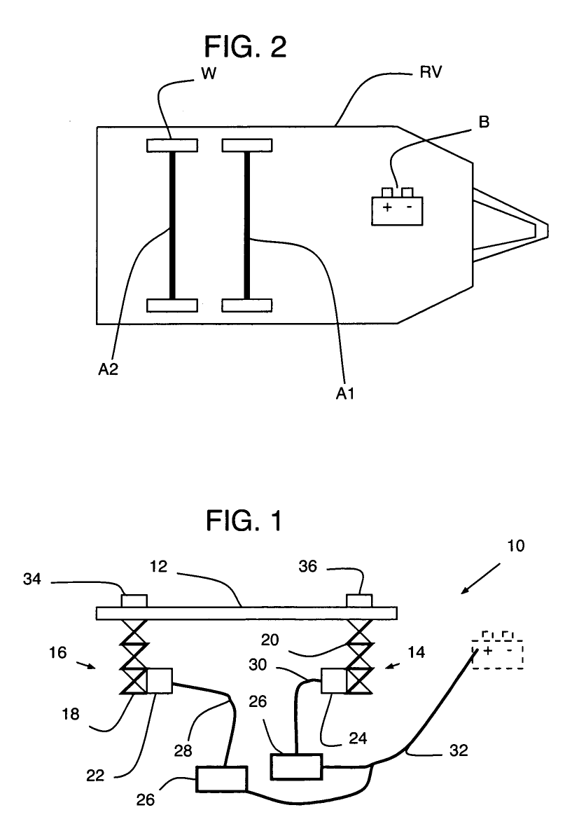

Making particular reference to the drawings, FIG. 1 shows one possible leveling system 10 according to the present invention and the system includes a central tube-type rail member 12 having a top surface adapted to couple two oppositely arranged pad elements 34 and 36, each pad element adapted to selectively engage one vehicle axle. Further, a first motorized jack unit 14 couples to a bottom surface of the rail 12, the first motorized jack unit comprising a first scissors-type mechanical jack device 20 coupled to an associated first electric motor 24. A second motorized jack unit 16 couples to the bottom surface of the rail, the second motorized jack unit includes a second scissors-type mechanical jack device 18 coupled to an associated second electric motor 22. A control box 26 electrically couples to the first and second electric motors via cables 28 and 30, respectively. The control box includes control elements to simultaneously actuate each first and second electric motor and further has a coupling means 32 to a battery B or power source provided by the vehicle RV.

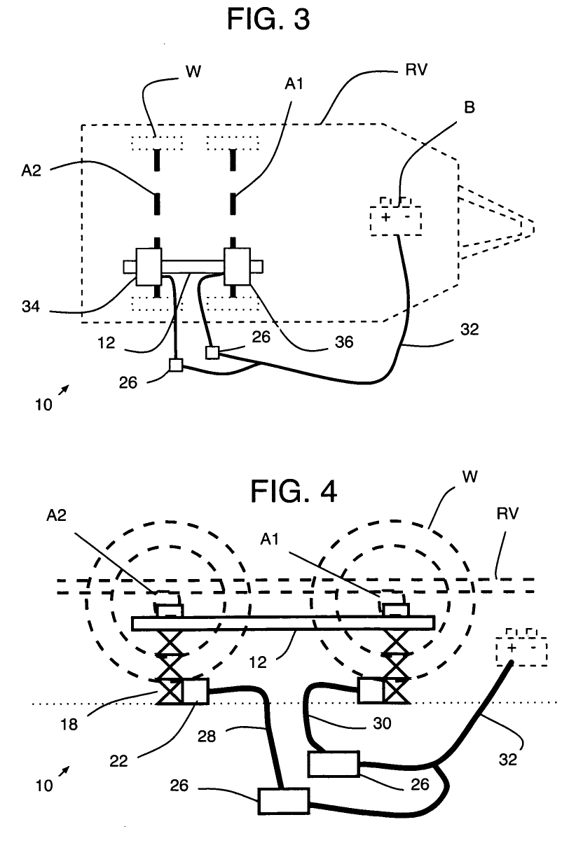

FIG. 3 shows a possible method of use on a recreational vehicle trailer (RV) having a battery B and tandem axles (A1 and A2) with associated wheels (W). The device of the present invention selectively engages both axles on one side of the vehicle simultaneously. The motorized leveler device 10 rests on the ground (as shown in FIG. 4, for example) and engages the under-side of each axle by coupling the interface pads 34 and 36 (or, in an alternative preferred embodiment, directly to rail 12). A pair of similar controllers 26 enables an operator easy operation of the leveler device because coupling cables electrically control the dual motors on the device to the control box or, preferably, to a pair of up/down switches—one for each motor to enable independent control of each motor. A second, electrically-coupling cable 32 connects the controller to an external power source such as the battery on the vehicle. Although shown as separate units, the pair of controllers 26 may be integrated into one single physical device.

FIG. 4 shows the device 10 in profile. Here, the side view of FIG. 3 shows the pads on the support beam member 12 lifting the axles off the ground. One possible pad has dimensions of about 1-inch by 12-inches by ¼-inch and having a resilient but sturdy coating including a hard-rubber compound as generally understood in this art.

In an alternative embodiment, the control box 26 may be wirelessly coupled to the electric motors on the leveling device, the motors being adapted with a wireless receiving device as commonly understood in the art. Also, a ratcheting jack or screw-type jack mechanism can be readily substituted with the scissors-type jack device.

Materials for the device include tubular steel having a high strength-to-weight ration, as would be well understood in the art. One possible frame material includes steel tubing having about a one-inch cross section and about 40-inches in overall length.

FIG. 5, an alternative embodiment according to the present invention, shows a side view of a leveling system. Notably, some elements are omitted. However, the aforementioned pad elements are not included in this preferred embodiment and the rail member 12 provides a top surface that is well-suited to engage the lower portion of the vehicle's axels and, further, this design adapts for use for any trailer or other vehicle regardless of axel spacing an, more importantly, may be used on a single axel or on a vehicle having only one axel. This preferred embodiment of a leveling device includes the top rail member 12 coupled to a pair of jack mechanisms 14 and 16, a first and second jack mechanism. As illustrated, the jack mechanisms 14 and 16 comprise a respective scissors-type mechanical jack 18 and 20. Each mechanical jack couples to an associated electric motor 22 or 24. Not shown in this figure are the controller means, power means, and coupling means.

In a preferred embodiment, the two electric motors include an extender cable with a connector, the extender cable links to the up and sown switches via mating connectors. The extender cables measure about 3 feet in length and prevent the up/down switches from dragging on the ground or from becoming entangled in the wheels.

Although the invention has been particularly shown and described with reference to certain embodiments, it will be understood by those skilled in the art that various changes in form and detail may be made without departing from the spirit and scope of the invention. And, although claims are not required, I claim at least:

I claim:

1. A leveling system for a vehicle having at least two axles, the system comprising:
a tube-type rail member having a top surface adapted to selectively and simultaneously engage the two vehicle axles,
a first jack unit coupling to a bottom surface of the rail, the first jack unit comprising a first scissors-type mechanical jack device having an associated first screw drive member;
a second jack unit coupling to the bottom surface of the rail, the second jack unit comprising a second scissors-type mechanical jack device having an associated second screw drive member;
a means for selectively coupling the first and second jack units to a remote power source whereby the remote power source comprises an automotive battery; and
the control box in communication with the first and second screw drive members, each member being further adapted to couple to a respective associated first and second electric motors, the control box comprising control elements to actuate each first and second electric motor.

2. The leveling system of claim 1 further comprising:
a hand winch assembly adapted to selectively couple to either the first or second screw drive member to enable manual manipulation of the respective first or second scissors-type mechanical jack device to enable operation of the system without use of the remote power source.

3. A leveling device adapted for use with a vehicle having at least one axis, the leveling device comprising:
a rail member;
a first jack mechanism coupled to the rail member, the first jack mechanism comprising
a first driving means for selectively extending and retracting from a first-jack first position to a first-jack second position;
a power means coupled to the driving means;
a controller means coupled to the driving means and adapted to selectively control the driving means to enable extension and retraction from the first-jack first and second positions; and
a second jack mechanism coupled to the rail member, the second jack mechanism comprising
a second driving means for selectively extending and retracting from a second-jack first position to a second-jack second position, the second driving means coupling to the power means and coupling to the controller means to enable extension and retraction from the second-jack first and second positions.

4. The leveling device of claim 3 wherein the first driving means comprises:
an electric motor coupled to the power means, the motor adapted selectively rotate clockwise and selectively rotate anti-clockwise an associated a screw-drive shaft;
a scissors-type mechanical jack assembly comprising a ground plate coupled to a first end of a scissors-frame adapted to retract and extend from the first-jack first position to the first-jack second position, the first scissors-type mechanical jack assembly adapted to engage the screw-drive shaft, and a second end coupled to the rail member.

5. The leveling device of claim 3 wherein the second driving means comprises:
an electric motor coupled to the power means, the motor adapted selectively rotate clockwise and selectively rotate anti-clockwise an associated a screw-drive shaft;
a scissors-type mechanical jack assembly comprising a ground plate coupled to a first end of a scissors-frame adapted to retract and extend from the first-jack first position to the first-jack second position, the first scissors-type mechanical jack assembly adapted to engage the screw-drive shaft, and a second end coupled to the rail member.

6. The leveling device of claim 3 wherein the power means comprises a hand-operated winch handle adapted to selectively couple to either the first or second driving means.

7. The leveling device of claim 3 further comprising:
a cable adapted to couple to a remotely located battery,
the cable further adapted to provide power to the controller means.

8. The leveling device of claim 3 wherein the rail member further comprises a segment of hollow tubing having oppositely spaced and open ends and further having a rectangular cross-section.

9. The leveling device of claim 3 wherein the controller means further comprises:
a control box adapted to house a first switch, the first switch being in electrical communication with, and adapted to selectively enable operation of, the first jack mechanism to extend and retract from its first position to its second position; and
the control box further adapted to house a second switch, the second switch being in electrical communication with, and adapted to selectively enable operation of, the first jack mechanism to extend and retract from its first position to its second position.

10. A method for leveling a trailer or other vehicle having two axels, the method comprising:
providing a leveling device having a rail member coupled to a first jack mechanism and a second jack mechanism whereby the first and second jack mechanism further comprise an associated first and second electric motor, each motor being independently operable between a respective first and second position by a controller means;
coupling the leveling device to a power source;
placing the leveling device under the trailer or other vehicle at a first under-vehicle location so that the rail member aligns with the two axels and extending the respective first and second jack mechanisms so the rail member contacts the respective axel; and
extending the first and second jack mechanism to a first desired position to cause the trailer or vehicle to be aligned in a fore-aft and left-right first level position.

11. The method of claim 10 further comprising:
placing blocking means under the trailer wheels;
retracting the leveling device; and
removing the leveling device from under the trailer or other vehicle.

12. The method of claim 11 further comprising:
placing the leveling device under the trailer or other vehicle at a second under-vehicle location so that the rail member aligns with the two axels and extending the respective first and second jack mechanisms so the rail member contacts the respective axel; and
extending the first and second jack mechanism to a second desired position to cause the trailer or vehicle to be aligned in a fore-aft and left-right first level position.

13. The method of claim 10 further comprising:
repairing the vehicle while the leveling device is in the first desired position.

14. The method of claim 10 further comprising:
selectively storing the leveling device on the trailer or other vehicle.
